(19) United States
(12) Patent Application Publication
(10) Pub. No.: US 2013/0162082 A1
(43) Pub. Date: Jun. 27, 2013

(54) SPINDLE MOTOR

(71) Applicant: SAMSUNG ELECTRO-MECHANICS CO., LTD., Suwon (KR)

(72) Inventor: Ju Ho KIM, Suwon (KR)

(73) Assignee: SAMSUNG ELECTRO-MECHANICS CO., LTD., Suwon (KR)

(21) Appl. No.: 13/706,686

(22) Filed: Dec. 6, 2012

(30) Foreign Application Priority Data
Dec. 22, 2011 (KR) 10-2011-0140128

(51) Int. Cl. H02K 5/16

(52) U.S. Cl. CPC H02K 5/165
USPC 310/90

(57) ABSTRACT

There is provided a spindle motor including: a sleeve forming a dynamic pressure generation space with a shaft; a hub including a main wall portion surrounding a circumference of the sleeve; and a cover disposed between the sleeve and the hub, wherein the sleeve and the cover have a storage unit formed therebetween, the storage unit storing a lubricating fluid.

### CROSS-REFERENCE TO RELATED APPLICATIONS

This application claims the priority of Korean Patent Application No. 10-2011-0140128 filed on Dec. 22, 2011, in the Korean Intellectual Property Office, the disclosure of which is incorporated herein by reference.

### BACKGROUND OF THE INVENTION

1. Field of the Invention

The present invention relates to a spindle motor and, more particularly, to a spindle motor able to minimize shortage of a lubricating fluid.

2. Description of the Related Art

A hard disk drive (HDD) includes a disk driving device, e.g., a small spindle motor, for driving a disk.

A small spindle motor has a hydrodynamic bearing structure so as to be reduced in size. In a hydrodynamic bearing structure, a fluid (i.e., a lubricating fluid) provided between a shaft, a rotating member, and a sleeve, a fixed member, serves as a bearing in a mechanical structure.

However, since the spindle motor rotates at high speed, the lubricating fluid provided between the shaft and the sleeve may be evaporated by a large amount of heat or may be leaked between the sleeve and a thrust plate.

Thus, development of a spindle motor in which evaporation of a lubricating fluid due to high speed rotation of the spindle motor and leakage of the lubricating fluid are minimized is required.

Meanwhile, Patent Documents 1 and 2 disclose a structure for storing a lubricating fluid. However, Patent Documents 1 and 2 have a structure in which a storage space of a lubricating fluid is open to the outside, lacking the capability to effectively prevent evaporation of a lubricating fluid.

### RELATED ART DOCUMENT

(Patent Document 1) KR2007-103903 A

(Patent Document 2) JP2006-161988 A

### SUMMARY OF THE INVENTION

An aspect of the present invention provides a spindle motor able to minimize evaporation and leakage of a lubricating fluid.

According to an aspect of the present invention, there is provided a spindle motor including: a sleeve forming a dynamic pressure generation space with a shaft; a hub including a main wall portion surrounding the circumference of the sleeve; and a cover disposed between the sleeve and the hub, wherein the sleeve and the cover have a storage unit formed therebetween, the storage unit storing a lubricating fluid.

The sleeve may include a flow channel allowing the lubricating fluid to circulate therethrough.

The cover may have a recess connecting the flow channel and the dynamic pressure generation space.

The storage unit may be formed in the cover.

The storage unit may be formed in the sleeve.

The cover and the hub may have a flow space formed therebetween to allow the lubricating fluid to move therein.

The cover may have a dynamic pressure groove formed in a surface thereof facing the hub.

The cover may be formed of a porous material.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view of a spindle motor according to a first embodiment of the present invention;

FIG. 2 is a cross-sectional view of a spindle motor according to a second embodiment of the present invention;

FIG. 3 is a cross-sectional view of a spindle motor according to a third embodiment of the present invention; and

FIG. 4 is a bottom perspective view of a cover illustrated in FIG. 3.

### DETAILED DESCRIPTION OF THE EMBODIMENTS

As a storage capacity of hard disk drives (HDD) has increased, a spindle motor able to rotate at high speeds has come to be required.

Namely, an existing spindle motor has a rotational speed of about 5400 rpm, requiring a relatively long time to write data to a large capacity HDD or read data stored on a large capacity HDD.

Thus, a spindle motor having a rotational speed of 7200 rpm or greater has been developed. However, in the case of the spindle motor having a high rotational speed, a lubricating fluid may be easily evaporated by heat generated during the high speed rotation, whereby durability of the spindle motor may be degraded.

In order to solve such a problem, the present invention may provide a spindle motor having a lubricating fluid storage space to minimize evaporation of the lubricating fluid due to high speed rotation.

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements may be exaggerated for clarity, and the same reference numerals will be used throughout to designate the same or like elements.

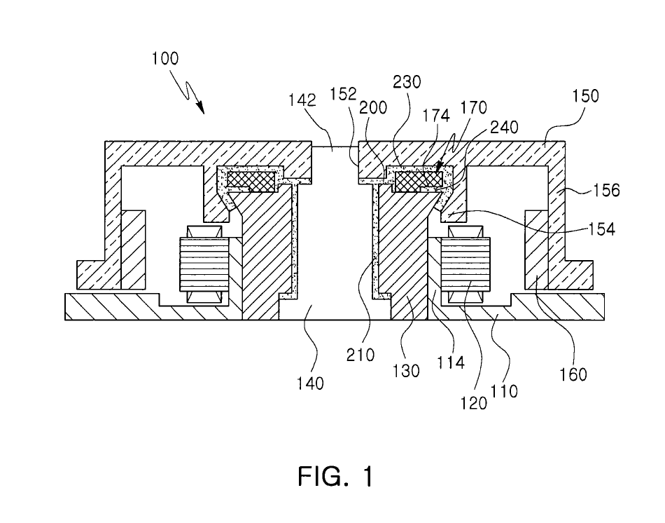

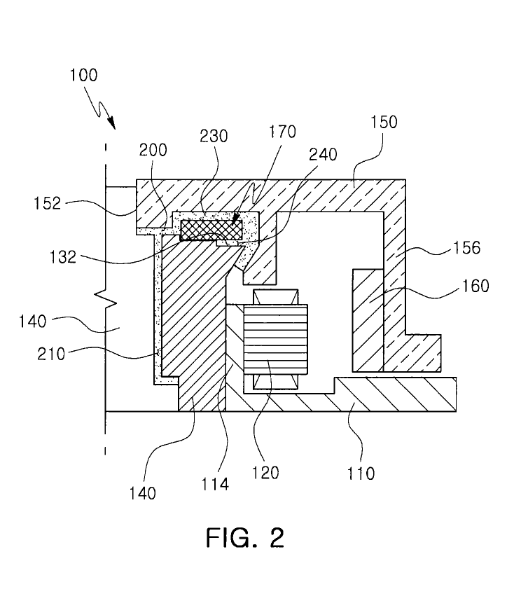

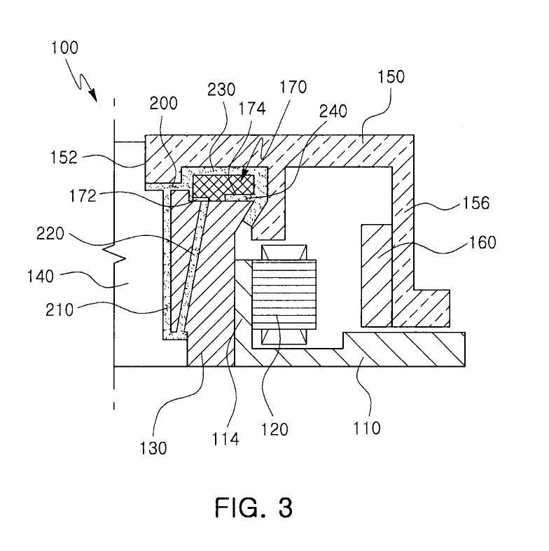

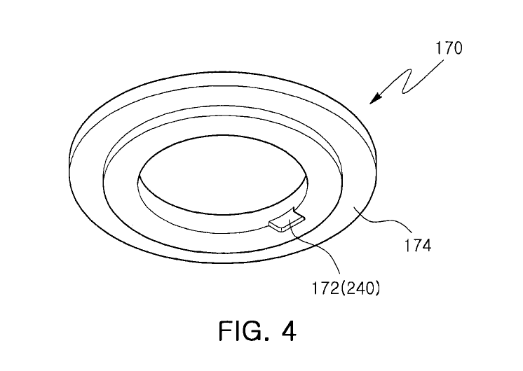

FIG. 1 is a cross-sectional view of a spindle motor according to a first embodiment of the present invention. FIG. 2 is a cross-sectional view of a spindle motor according to a second embodiment of the present invention. FIG. 3 is a cross-sectional view of a spindle motor according to a third embodiment of the present invention. FIG. 4 is a bottom perspective view of a cover illustrated in FIG. 3.

A spindle motor according to a first embodiment of the present invention will be described with reference to FIG. 1.

A spindle motor 100 according to the first embodiment of the present invention may include a base member 110, an electromagnet 120, a sleeve 130, a shaft 140, a hub 150, a permanent magnet 160, and a cover 170. A storage unit 240 storing a lubricating fluid 200 may be formed between the sleeve 130 and the cover 170.

The base member 110 may be a member firmly fixed to a body of a hard disk drive device so as not to be moved. Thus, the base member 110 may be a body or a portion of the hard disk drive device. The base member 110 may be formed of a metal (e.g., an aluminum alloy, or the like). The base member 110 may have an installation hole allowing the sleeve 130 to be installed therein.

The installation hole may have the same diameter as that of an outer diameter of the sleeve 130 or may have a diameter having a difference within a certain tolerance range. An first main wall portion 114 may be upwardly protruded from the edge of the installation hole in order to stably support the circumference of the sleeve 130. A plurality of electromagnets 120 may be installed on the first main wall portion 114.

The electromagnet 120 may be disposed in a circular manner based on the installation hole, and may generate electromagnetic force upon receiving a current from the outside. To this end, the electromagnet 120 may include a core and a coil.

The sleeve 130 may be installed in the base member 110. The sleeve 130 may be firmly fixed to the base member 110 in a press-fitting manner, and may be fixedly bonded thereto using an adhesive, or the like, as necessary. The sleeve 130 may have a through hole accommodating the shaft 140. Here, the diameter of the through hole may be greater than an outer diameter of the shaft 140.

A dynamic pressure generation space 210, provided with the lubricating fluid 200, may be formed between an inner surface of the sleeve 130 and an outer surface of the shaft 140. In detail, although not shown, fluid dynamic pressure grooves in the form of the teeth of a comb may be formed in the sleeve 130 or the shaft 140 to generate dynamic pressure when the shaft 140 is rotated.

The fluid dynamic pressure grooves may have any shape among a herringbone shape, a spiral shape, and a helical shape, and may have any shape as long as they generate dynamic pressure.

The shaft 140 may be rotatably installed in the sleeve 130. The shaft 140 may be installed to penetrate the sleeve 130 and have an extended portion extending outwardly (i.e., upwardly based on FIG. 1) of the sleeve 130. The extended portion may have the same area as that of the shaft 140, or may have a different area thereto, as in the present embodiment.

The hub 150 may be coupled to the shaft 140. In detail, the hub 150 may be coupled to the extended portion 142 of the shaft 140 and may be rotated together with the shaft 140. For reference, a shaft coupling hole 152 into which the shaft 140 is inserted may be formed in the hub 150.

The hub 150 may have a second main wall portion 154 and a third main wall portion 156.

The second main wall portion 154 may be formed to extend downwardly in the vicinity of the sleeve 130 of the hub 150. The downwardly extending second main wall portion 154 may surround the circumference of the sleeve 130. The second main wall portion 154 may restrain a fluid from being leaked to the outside of the sleeve 130.

A flow space 230 through which the lubricating fluid 200 passes may be formed between the second main wall portion 154 and the sleeve 130. In detail, a space between the second main wall portion 154 and the sleeve 130 may be connected to the dynamic pressure generation space 210 between the sleeve 130 and the shaft 140 and provided with the lubricating fluid 200. The lubricating fluid provided in the space may be provided to the dynamic pressure generation space 210 so that a shortage of the lubricating fluid may not exist in the dynamic pressure generation space 210.

The third main wall portion 156 may extend downwardly from the edge of the hub 150. The downwardly extending third main wall portion 156 may surround the outside of the electromagnet 120.

The permanent magnet 160 may be installed on the third main wall portion 156. In detail, the permanent magnet 160 may be disposed on the third main wall portion 156 such that it faces the electromagnet 120 disposed on the first main wall portion 114. The permanent magnet 160 generates electromagnetic force equivalent to that of the electromagnet 140. Thus, the electromagnet 120 and the permanent magnet 160 may form a magnetic field having a certain magnitude to allow the shaft 140 and the hub 150 to be rotated.

A plurality of disks may be installed on the third main wall portion 156. Here, the disks may be members for writing and magnetic information to the HDD and reading information therefrom.

The cover 170 may be disposed between the sleeve 130 and the hub 150.

The cover 170 may be formed of a porous material or may be fabricated through a sintering method such that the cover 170 may have a plurality of pores formed therein. The cover 170 may absorb a lubricating fluid therein, so that the cover 170 itself may be used as a lubricating fluid storage space.

The cover 170 may have a step 174. The step 174 may be formed in a lower surface of the cover 170 (i.e., a surface facing the sleeve 130), and may be formed to extend in a circumferential direction of the cover 170.

The step 174 may form the storage unit 240 storing the lubricating fluid between the lower surface of the cover 170 and the upper surface of the sleeve 130.

The cover 170 may have a dynamic pressure groove. In detail, a fluid dynamic pressure groove may be formed in a surface of the cover 170 facing the hub 150. With this structure, physical contact between the hub 150 and the cover 170 is minimized, whereby abrasion of the cover 170 may be prevented.

The spindle motor 100 configured as described above may further include the lubricating fluid storage unit formed between the sleeve 130, the cover 170, and the second main wall portion 154, and thus, the shortage of the lubricating fluid due to high speed rotation of the spindle motor may be minimized.

Other embodiments of the present invention will be described with reference to FIGS. 2 through 4.

The spindle motor 100 according to the second embodiment of the present invention may be differentiated from that of the first embodiment, in that a step 132 is formed in the sleeve 130.

In the present embodiment, the lubricating fluid storage unit 240 may be formed in the sleeve 130. In detail, the lubricating fluid storage unit 240 may be formed in the step 132 of the sleeve 130 and the lower surface of the cover 170.

In the spindle motor 100 configured as described above, since the lubricating fluid storage unit 240 is formed by processing the relatively thick sleeve 130, the lubricating fluid storage unit 240 can be easily formed and can easily extend.

The spindle motor 100 according to the third embodiment of the present invention may be differentiated from the foregoing embodiments, in that a flow channel 220 is formed in the sleeve 130.

Also, the spindle motor 100 according to the third embodiment of the present invention may be differentiated from the foregoing embodiments, in that a recess 172 is formed in the cover 170.

The sleeve 130 may have the flow channel 220 connected to the dynamic pressure generation space 210. The flow channel 220 may be formed to penetrate the sleeve 130 in a vertical direction and may be connected to the dynamic pressure generation space 210 and the recess 172 of the cover 170.

The flow channel 220 may allow the lubricating fluid 200 to circulate such that the dynamic pressure generation space 210 is filled with a predetermined amount of lubricating fluid 200.

The cover 170 may have the recess 172 and the step 174. In detail, as shown in FIG. 4, the recess 172 and the step 174 may be formed in the lower surface of the cover 170.

The recess 172 may be connected to the flow channel 220, and may be connected to the flow space 230 between the hub 150 and the cover 170 as necessary.

The recess 172 may allow the lubricating fluid 200 provided in the dynamic pressure generation space 210 and the flow channel 220 to circulate smoothly, and the step 174 may form the lubricating fluid storage unit 240 between the cover 170 and the sleeve 130.

The spindle motor 100 configured as described above has a structure in which the lubricating fluid 200 circulates through the dynamic pressure generation space 210, the flow channel 200 and the flow space 230, and thus, heat generated when the spindle motor 100 is rotated may be naturally dissipated to the outside in the circulation process of the lubricating fluid 200.

In addition, since the present embodiment has the structure preventing a shortage of the lubricating fluid due to the lubricating fluid of the storage unit 240, insufficiency of the lubricating fluid due to high speed rotation of the spindle motor 100 can be minimized.

As set forth above, according to embodiments of the invention, since a relatively large lubricating fluid storage space is provided, a degradation in the performance of the spindle motor due to evaporation of a lubricating fluid can be minimized.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a sleeve forming a dynamic pressure generation space with a shaft;
a hub including a main wall portion surrounding a circumference of the sleeve; and
a cover disposed between the sleeve and the hub,
wherein the sleeve and the cover have a storage unit formed therebetween, the storage unit storing a lubricating fluid.

2. The spindle motor of claim 1, wherein the sleeve includes a flow channel allowing the lubricating fluid to circulate therethrough.

3. The spindle motor of claim 2, wherein the cover has a recess connecting the flow channel and the dynamic pressure generation space.

4. The spindle motor of claim 1, wherein the storage unit is formed in the cover.

5. The spindle motor of claim 1, wherein the storage unit is formed in the sleeve.

6. The spindle motor of claim 1, wherein the cover and the hub has a flow space formed therebetween to allow the lubricating fluid to move therein.

7. The spindle motor of claim 6, wherein the cover has a dynamic pressure groove formed in a surface thereof facing the hub.

8. The spindle motor of claim 1, wherein the cover is formed of a porous material.
